(19) United States
(12) Patent Application Publication
(10) Pub. No.: US 2011/0078131 A1
(43) Pub. Date: Mar. 31, 2011

(54) EXPERIMENTAL WEB SEARCH SYSTEM

(75) Inventors: Ji-Rong Wen, Beijing (CN); Yu Chen, Beijing (CN); Guomao Xin, Beijing (CN); Yunxiao Ma, Beijing (CN); Yi Liu, Beijing (CN); Zhicheng Dou, Beijing (CN); Qing Yu, Beijing (CN); Shuming Shi, Beijing (CN)

(73) Assignee: Microsoft Corporation, Redmond, WA (US)

(21) Appl. No.: 12/569,978

(22) Filed: Sep. 30, 2009

(51) Int. Cl. G06F 7/10; G06F 17/30

(52) U.S. Cl. 707/711; 707/E17.109

(57) ABSTRACT

Described is the running of search-related experiments on a full (or partial) offline snapshot copy of the search engine documents of an actual production system. A snapshot experimentation subsystem runs experimental code related to web searches on the offline data, including to run experimental index building code to build an experimental index (e.g., to test a new document feature), and/or to run experimental search-related code, such as to rank search results according to experimental ranking code, to implement an experimental search strategy, and/or to generate experimental captions.

### CROSS-REFERENCE TO RELATED APPLICATION

The present application is related to United States patent application Ser. No. ______ (attorney docket no. 327768.01), entitled “Flexible Indexing and Ranking for Search,” filed concurrently herewith and hereby incorporated by reference.

### BACKGROUND

Web search engine providers are in a competitive business. To satisfy the requirements of end-users so as to gain new users and keep existing users from switching to a competing search engine, search providers need to continuously improve the quality of the search results returned to the users.

To improve the quality of search results, search engine providers experiment with many new ideas to see which ones are effective. This includes coming up with new ways to re-rank the results of a specific query set, and new ways to build indexes, e.g., via new features. To experiment with a new idea, small datasets are used. However, in practice, many ideas which are shown to be promising in small datasets, and/or ideas for re-ranking experiments, turn out to not be effective in the production system, and indeed may make the quality of the search results worse.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which search-related experiments may be run on a full or partial snapshot copy of search engine data used in an actual production system. In one implementation, an experimental repository maintains page content and metadata synchronized from the actual data used by a production search engine. A metadata extraction subsystem processes documents and extracts features based upon the page content and metadata of the experimental repository to provide offline data. A snapshot experimentation subsystem runs experimental code related to web searches on the offline data, including to run experimental index building code to build an experimental index, and/or to run experimental search-related code, such as to rank search results according to experimental ranking code, to implement an experimental search strategy, and/or to generate experimental captions.

In one implementation, multiple users may run experiments simultaneously as scheduled by a master component of the snapshot experimentation subsystem. A front end component allows user interaction with the snapshot experimentation subsystem, e.g., to submit queries and obtain search results. In general, the use of multiple index units allows users to quickly apply newly extracted features into the index, e.g., by only needing to re-build part of the index.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example search environment including an offline experimentation web search system.

FIG. 2 is a block diagram representing subsystems (clusters) of an offline experimentation web search system, including an experimental repository subsystem, a metadata extraction subsystem, and a snapshot experimentation subsystem.

FIG. 3 is a block diagram representing example interfaces of the experimental repository that stores a copy of actual search documents for use in experimental processing.

FIG. 4 is a block diagram representing example interfaces of the metadata extraction subsystem for processing the data experimental repository.

FIG. 5 is a representation of an example structure of the metadata extraction subsystem.

FIG. 6 is a block diagram representing example interfaces of the snapshot experimentation subsystem that uses the data of the metadata extraction subsystem to run experiments.

FIG. 7 is a block diagram representing example components of the snapshot experimentation subsystem as coupled to client computing devices, including index building and serving nodes.

FIG. 8 is a block diagram representing example components of an index building and serving node.

FIG. 9 shows an illustrative example of a computing environment into which various aspects of the present invention may be incorporated.

### DETAILED DESCRIPTION

Various aspects of the technology described herein are generally directed towards an experimental search system for facilitating large-scale, end-to-end search experiments which generate reliable experimentation results. As will be understood, the experimental search system provides reliable experiments so that search improvements can be reproduced in a production system, along with facilitating straightforward and flexible experimentation with respect to implementing experimental logic and/or performing various types of experiments. Further, in one implementation, multiple users can simultaneously and efficiently perform independent experiments without interfering with each other, although when desired, users can also share the resources (data and experimental logic) of other users. Also described is monitoring and debugging, so that experimenters are able to monitor the progress of their experiments and obtain information from the system to find out the reasons for any errors.

It should be understood that any of the examples herein are non-limiting. Indeed, as one example, a particular implementation having various components and interfaces is described, however this is only one example. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and search technology in general.

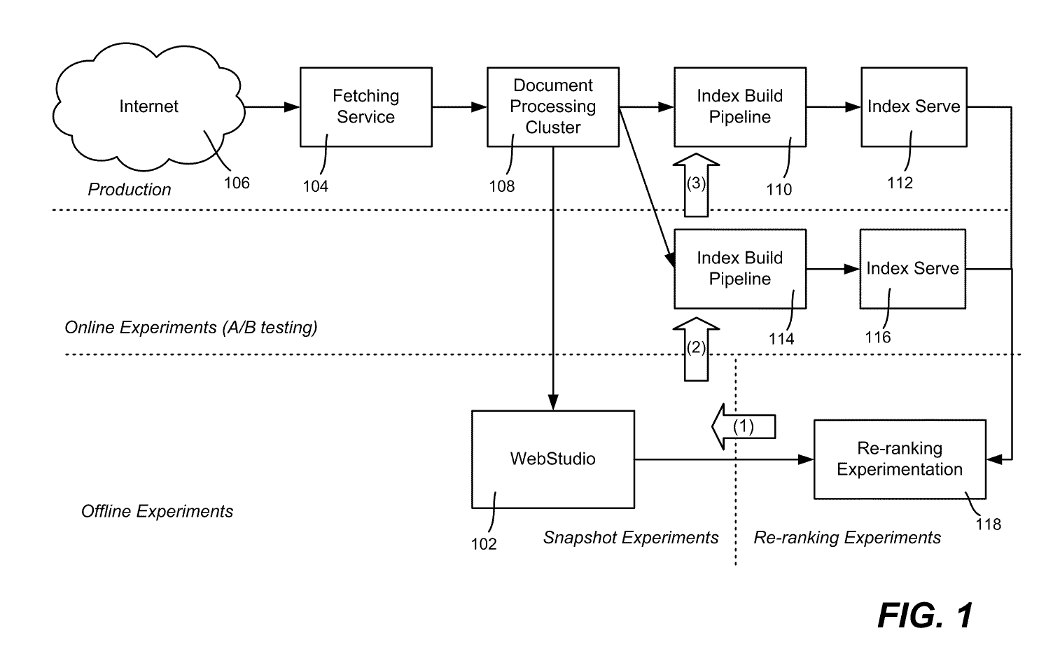

Turning to FIG. 1, there is shown an example implementation as to how one experimental web search system described herein, referred to as WebStudio 102, fits into a search environment. In general, at a production level of an online production system, a fetching service 104 retrieves documents from the Internet 106. These documents are processed by a document processing cluster 108, and used to build an index (block 110), which may then be accessed as needed (block 112).

At another level shown in FIG. 1 is an online experiments system, also known as A/B testing, which generally ensures that before putting a new algorithm/data into the online production system, the real user experience is as what is expected. The online experimental system hosts such new algorithms/data in an NB testing index (blocks 114 and 116), which is operated in parallel with the online production system. Some queries are redirected to the online experimental system, providing an opportunity for actual user feedback related to the testing system. Online experimentation is thus based on fresh data, and possibly also based upon actual user feedback.

With respect to offline experimentation, types of experiments that can be run include snapshot experiments and re-ranking experiments. In snapshot experiments, a snapshot of the crawled web pages is indexed, and an experimental search engine is built. In the experimental search engine, a query is able to be processed by the same process as in the production system, (with the exception that the data/web pages are less fresh). This allows the effectiveness of experimental feature usage to be tested accurately. Re-ranking experiments refer to the activities of re-ordering the top-k results of a list of search engines via a ranking function, where k might be a relatively small (e.g. 5, 10, 100) or relatively larger number (e.g. 1,000, 4,000, 10,000).

The WebStudio 102 synchronizes web pages from the document processing cluster 108 of the production pipeline and may maintain multiple page snapshots. Experimental users (e.g., developers or researchers) choose a snapshot and build an end-to-end search engine via WebStudio 102 for that snapshot. Users can customize major operations including document parsing, page classification, index building, index serving, and front-end processing in the end-to-end search engine, by adding their own experimental logic for testing ideas. Any non-experimental logic may be reused in conjunction with the experimental logic. As described below, as an end-to-end search system, the WebStudio 102 provides search interfaces, by which external systems (including people) can input queries and get search results.

By way of example, a re-ranking experimentation system 118 is able to input a query list and get search results from the WebStudio 102. These results may be evaluated, such as against test data, to see if the experimental re-ranking improved the quality of the search results.

The arrows labeled (1), (2), and (3) in FIG. 1 illustrate the procedure of testing and verifying ideas and features. By way of example, assume there are fifty ideas for improving search relevance that are to be experimentally implemented to test the effectiveness of each via re-ranking experiments. Each may be fully tested, but further assume that small scale testing finds that only twenty pass the smaller test. Because an idea that passes re-ranking experimentation may not work in the production system, the twenty ideas may be further tested via end-to-end snapshot experiments on the WebStudio 102, (arrow (1)). After the snapshot experiments, only five ideas remain as viable candidates in this example. These five are tested via online experiments (arrow (2)). After verification via online experimentation, any remaining ideas may be implemented into the production system, as illustrated by arrow (3).

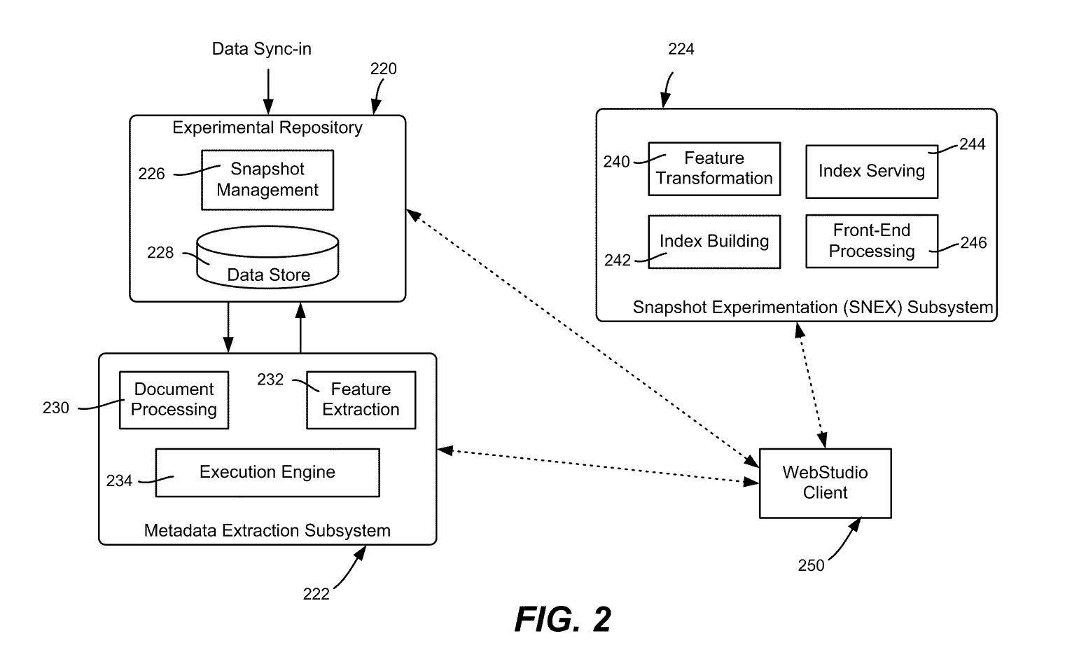

Turning to additional details, in one implementation of the WebStudio 102 as represented in FIG. 2, there are three types of subsystems (also known as virtual clusters), namely an experimental repository 220, a metadata extraction subsystem 222 and a snapshot experimentation (SNEX) subsystem 224. The experimental repository 220 builds (via block 226) and maintains a data store 228 comprising multiple web snapshots and related data (e.g. query sets and judgments) for experiments. The experimental repository 220 uses the data store 228 to persistently store web pages and other types of data. The experimental repository 220 (continuously or in batch) gets data from the document processing cluster 108 of the production system. The data transfer from the document processing cluster 108 to the experimental repository 220 may be in push mode or in pull mode, depending on policy and/or the interface provided by the document processing cluster 108.

The metadata extraction (cluster) subsystem 222 extracts in-band and out-of-band document features, which are used in the index building and ranking experiments of the snapshot experimentation subsystem 224. In one implementation, the experimental repository subsystem 220 is the repository for storing and managing multiple web snapshots. The metadata extraction subsystem 222 is generally in charge of in-band document processing 230 (document parsing and classification), and out-of-band feature extraction 232 (including static-rank computation).

To perform these operations, an execution engine 234 of the metadata extraction cluster subsystem 222 may retrieve specific rows and columns from the data store 228 of the experimental repository 220, perform the processing, and write the extracted features (e.g., as new columns) back into the data store 228 of the experimental repository 220 through a snapshot management module.

The operations that are related to indexing and ranking are performed in the snapshot experimentation subsystem 224. Note that a feature transformation operation may be performed (block 240) to transform a document feature into a format (e.g. indexable document format) which can be directly indexed by the index builder 242. Feature transformation may be treated as a preprocessing step for index building.

The snapshot experimentation subsystem 224 allows users to run index building 242, index serving 244, and front-end processing tasks 246. The snapshot experimentation subsystem synchronizes snapshots from the experimental repository subsystem 220 and enables users (e.g., the WebStudio client 250) to perform indexing and ranking experiments based on the snapshots. A snapshot may be a full web snapshot, e.g., containing all the web pages indexed by the production system (e.g., on the order of twenty billion web pages), or possibly all the pages that have ever been on the document processing, or a partial snapshot, e.g., containing some subset of web pages.

In performing experiments to test the effectiveness of a new feature, experimenters may first start an index building task (block 242), and a new index unit (described below) is generated from the pages in the snapshot. Then an index serving task 244 and a front-end task 246 are performed, from which new ranking results are retrieved and the effectiveness of the new feature is evaluated. An experimenter can also directly start from the index serving task 244 and a front-end task 246. For example, this may be done to perform ranking experiments without changing the index's data. As another example, an experimenter can use the existing generated index units (self-generated or shared from another experimenter) to compose a new experiment.

In one implementation, the snapshot experimentation subsystem also hosts data probing and analysis tools for facilitating analysis and diagnosis.

Note that the amounts of data being processed are extremely large, and the experimental repository, metadata extraction subsystems, and snapshot experimentation subsystems are virtual clusters; they are not necessarily physical clusters. Different deployment options provide different possibilities of mapping subsystems to physical clusters. Factors when considering deployment include system maintainability, performance (including time for synchronizing snapshots, index building speed, and query processing speed), and cost (e.g., based upon the number of machines required, inter-cluster and intra-cluster bandwidth requirements and disk and memory requirements). Note that different deployment options may have different requirements to the number of machines (and also CPU, memory, and disk) in each physical cluster.

For example, in one example deployment option, two large physical clusters may be provided, namely an experimental repository-main cluster and a snapshot experimentation-main cluster. In this example, the metadata extraction cluster subsystem is located on the same physical cluster (on the order of thousands of machines, such as 2,000) with the experimental repository subsystem, which enables metadata extraction to be performed on the machine/server cluster where the data is stored. The full snapshot experimental subsystem may be a generally similar number of machines (e.g., 1,500). In addition, there may be smaller snapshot experimentation clusters for performing experiments based on partial snapshots (e.g., two such clusters of 50 machines each).

An alternative example deployment option is to have only one large physical cluster (e.g., comprising 3,500 machines), in which the metadata extraction cluster, experimental repository, and snapshot experimentation subsystems are located on the same physical cluster. Similar to the other deployment option, two small snapshot experimentation clusters (e.g., two such clusters of 50 machines each) may be provided to synchronize partial snapshots from the large physical cluster to facilitate experiments on a subset of data.

As can be readily appreciated, one advantage of a single physical cluster over multiple physical clusters is that the data transfer from the experimental repository to the snapshot experimentation subsystem is avoided. However, the performance of index building and query processing experiments may be reduced by the snapshot management operations performed on the same cluster. Thus, a consideration when choosing a deployment may be how many experiments are to be performed on full snapshots.

As described above, the experimental repository 220 stores the document contents and metadata used for doing offline experiments, as continuously or periodically synchronized from the online document processing cluster 108 in the production system. Data from other sources (e.g. query logs, manually crawled pages, evaluation results, and so forth) also may be included. Note that multiple snapshots of the web may be stored, because different experiments may need to retrieve different data snapshots, for example.

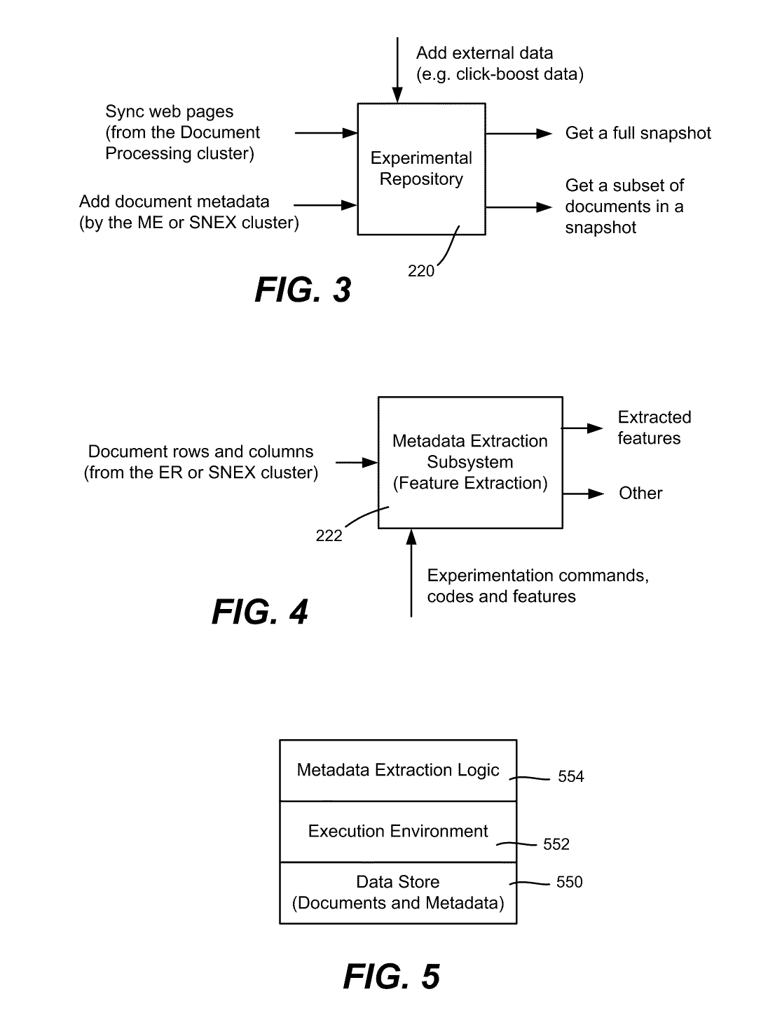

Interfaces of the experimental repository include those shown in FIG. 3, and include input interfaces to obtain web pages from the document processing cluster 108, and to receive document metadata from metadata extraction cluster or snapshot experimentation. Other external data may be input, such as click-boost data, a spam list, and so forth.

Output interfaces provide for outputting a full snapshot, e.g., all rows (web pages, queries, and so forth) and columns (metadata) of a specific snapshot. Another output allows a caller to retrieve rows and columns according to specific filtering conditions and/or a list of URLs; by way of example, one caller may ask to retrieve all English web pages in a “Dec2008” snapshot, while another caller may ask to retrieve a random sample of 100 million product web pages from a “Sep2008” snapshot.

The metadata extraction subsystem 222 generates derived features for documents, sites, and/or queries. One such metadata extraction subsystem 222 may be dedicated to the generation of one feature (e.g. static-rank) or shared by multiple feature extraction tasks. The metadata extraction subsystem 222 may perform tasks such as HTML parsing, word breaking, site-map building, (advance) anchor text extraction, pornographic content detection, product page classification, and so forth. Note however that many of these operations are also supported on the snapshot experimentation cluster, because their corresponding features can be extracted in an in-band way. This provides flexibility for user experiments.

FIG. 4 shows example interfaces of the metadata extraction subsystem 222. An input interface provides a mechanism for retrieving specific columns of a specific set of documents, based on which new features are going to be extracted. For example, one advanced anchor accumulation task may require the forward-links column of the pages in a snapshot. Experimentation commands and codes also may be input via an interface, including scope commands, user-defined logic about how to extract new features from a document, and so forth.

The output interface provides callers with the extracted features. Other interfaces may be used to provide debugging information, e.g., by which users can determine the reason for a task failure, and to provide status and progress information of tasks (e.g. the number of pages processed).

In one implementation represented in FIG. 5, the metadata extraction subsystem 222 contains a data store 550, an execution environment 552 and metadata extraction logic 554. The data store 550 maintains the documents for metadata extraction and extracted metadata. Document changes may be merged with the current document set, e.g., periodically. The execution environment 552 facilitates various metadata extraction algorithms; the metadata extraction logic 554 represents these metadata extraction algorithms.

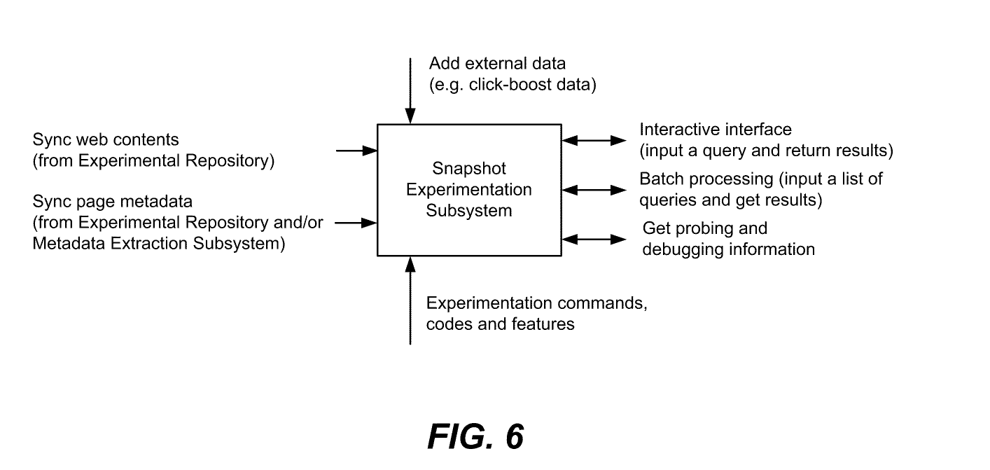

Example interfaces of the snapshot experimentation subsystem 224 are represented in FIG. 6. Input interfaces provide a mechanism for receiving snapshot data, including raw web page content and derived metadata (extracted via the metadata extraction subsystem), e.g., from the same or a different physical cluster. An input for external data such as click-boost data, a spam list, and so forth is provided, as is an input to provide experimentation commands and codes, including the commands for synchronizing a new snapshot, such as importing a new DLL (written by an experimental user) and starting a new task.

Other interfaces provide an interactive interface for search results, e.g., a search user interface that gets the top-k results given a list of queries; (note that k can be arbitrarily set). Alternatively, batch processing may be performed on another interface, to provide a list of queries and get results for that list.

Still other interfaces are related to probing information for diagnosis, e.g., example, the anchor-text of a page, the word-breaking results of a query, and so forth, and debugging information, e.g., when an indexing process fails, users can determine the reason. Status and progress data are likewise available via an interface in this example implementation.

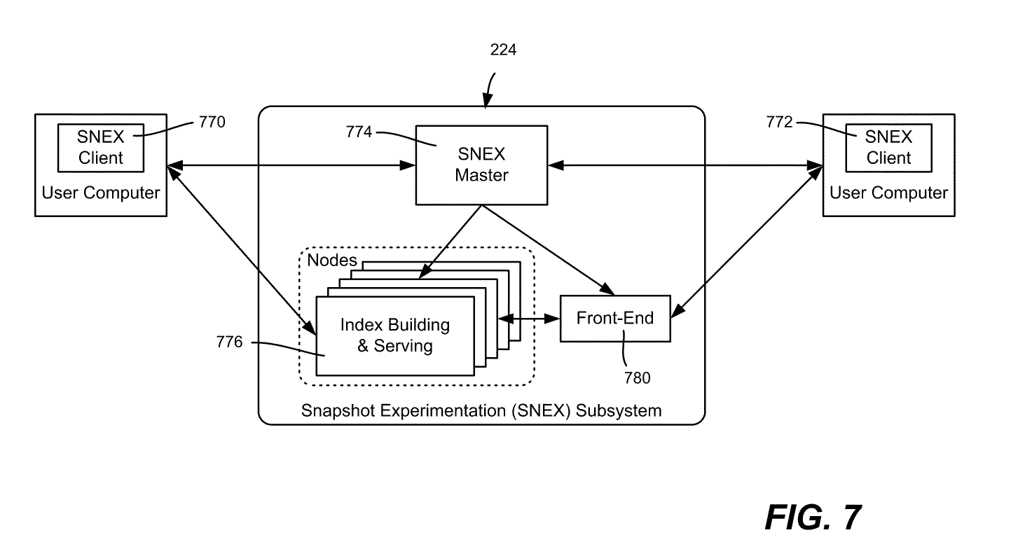

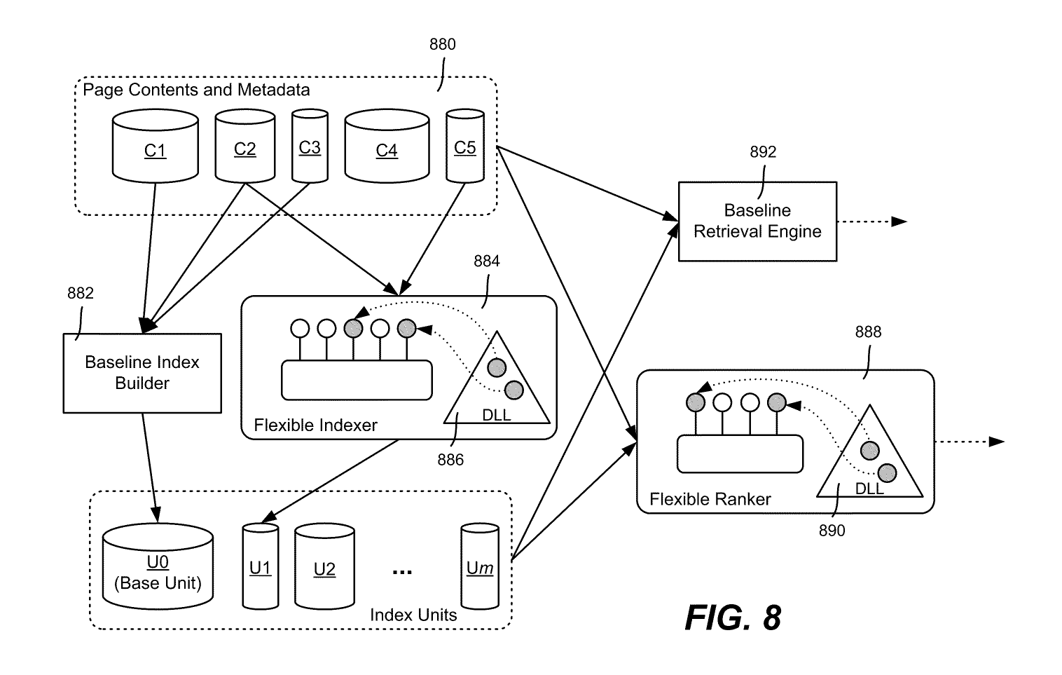

FIGS. 7 and 8 provide additional details of the architecture and usage of one implementation of a snapshot experimentation (SNEX) subsystem 224 accessed by user clients 770 and 772. In general, the snapshot experimentation subsystem 224 builds an inverted index for a large-scale web snapshot, as well as provides search and ranking functionality based on the inverted index. This is accomplished by a flexible indexer that builds an inverted index for a web snapshot, a retrieval engine that generates search results, and a front-end processor, e.g., for processing queries, merging search results, and providing search results caching. These modules may be distributed among many machines of a cluster, and can be customized by the experimenters.

A user (e.g., represented by the client 770) adds an experimental feature into the index by building a DLL (dynamic-link library), and submitting the DLL into the snapshot experimentation cluster via a snapshot experimentation client (e.g., the client 770). The user then attempts to invoke a customized index building service with the submitted DLL. Note that other users (e.g., represented by the client 772) may also submit their own DLLs and ask to initiate their index-building tasks respectively.

A snapshot experimentation master component (e.g., a machine) 774 receives the requests and determines how to schedule them. For example, it may decide to run two or more different users' tasks simultaneously, and hold another user's task (or multiple other tasks) in a pending state. The master component 774 sends the job scheduling information to the index building and serving nodes 776.

After receiving the job scheduling commands from the master component 774, each index building and serving node may first start the two simultaneous tasks in this example. After these tasks are accomplished, the task that was pending starts to run. Each user can view the execution status of their jobs via their respective client. Other schedules are feasible.

Via a client (represented by 772), the user may communicate with a front end component 780 that performs web user interface functions, as well as search results aggregation and caching. Users can also insert experimentation logic (via DLLs) into the snapshot experimentation subsystem, and start an index building task and/or start and stop a ranking service. Users may also monitor the status of index building tasks or ranking services.

FIG. 8 shows additional details of an index building and serving node, which includes components for flexible indexing and ranking as described in the aforementioned related patent application. In general, the page contents and metadata 880 may be divided as desired, which in this example is in five columns (C1-C5), namely raw web pages C1, anchor-text C2, static-rank C3, parsed pages C4 and URLs C5. The indexes are built as sets of index units U0-Um. Note that the use of multiple index units reduces the chance that users' experiments disturb one another. By storing a base index in the baseline unit U0, and incremental indexes according to specified columns/new features in separate index units U1-Um (which are actually different files from the base index file or files), the index building time is small for small streams.

To this end, a baseline index builder 882 builds a base unit U0, and a flexible indexer 884 builds the incremental index units U1-Um based upon user submitted DLLs 886, e.g., that specify which columns to use, a new feature set, and so forth. The flexible indexer 884 thus allows each user to experiment with index building relative to the base index, e.g., via one or more new features.

For ranking and other search-related experiments, a flexible ranker 888 allows user submitted DLLs 890 to perform the ranking, (although there may not be any such DLLs in a given experiment that only varies index building). For example, a user may submit an experimental ranking function with a new way to compute document scores, and/or a new search strategy for finding relevant pages. A new caption generator may similarly be uploaded for experimenting with its results. In this manner, different ranking experiments may be conducted instead of or in addition to index building experiments. A baseline retrieval engine 892 allows access to the page contents and metadata 880 and the baseline index unit U0 to provide search results for comparing against the experimental search results provided via the ranker 888.

The ranking module can load several index units together and make these index units that are served together appear to be one large index. It is transparent to the users how the data is stored, e.g., whether in one index unit or in multiple index units. The flexible ranker provides interfaces for a user's ranking function to access index data. The served index units are generated from the same data set (web snapshot). However, the index units can be generated from different fields or features of web pages. For example, the base unit may be generated from the full content of web pages, with other index units generated from the anchor text, click boost and so forth. Index units can also be generated by different experimenters for different times. The flexible ranker automatically assigns these index units together to form a virtual large index.

The flexible ranker also allows users to replace a feature in one index unit by a newly extracted feature in another index unit. For example, one user may implement an advance anchor extraction algorithm, extract a new “anchor text” feature and build an index unit for the new anchor text feature. Then the user can configure the flexible ranker to use new anchor text in the newly generated index unit to replace the one in the original index unit (for example, the base index unit). Index units thus enable the experimenter to quickly test an idea. Further, because search data is very large, it takes a significant amount of time and resources to otherwise rebuild an index to add new data or extract new features. With the flexible ranker, the experimenter need only build the new data/features into a small index unit and let the flexible ranker combine (add or replace) it with the original index unit (e.g. base index unit). The experimenter can also use others' index units to perform experiments.

As can be seen, there is provided a technology for conducting end-to-end experiments based on a full web document (web page) snapshot, along with mechanisms that allow experimenters to customize experimental search engines. This is in part accomplished via a flexible index building and serving mechanism that allows building/modifying index incrementally and efficiently, e.g., by splitting the index into multiple index units that can be each built/modified independently, greatly saving index building time. The retrieval engine can use one or more index units to produce a combined experimentation search engine.

Experimenters can share their experiments with others, including index units and related codes, in order to enable easy collaboration of search engine experimentation. Further, experimenters can insert DLLs to implement and add various types of experimentation logic into the system.

### Exemplary Operating Environment

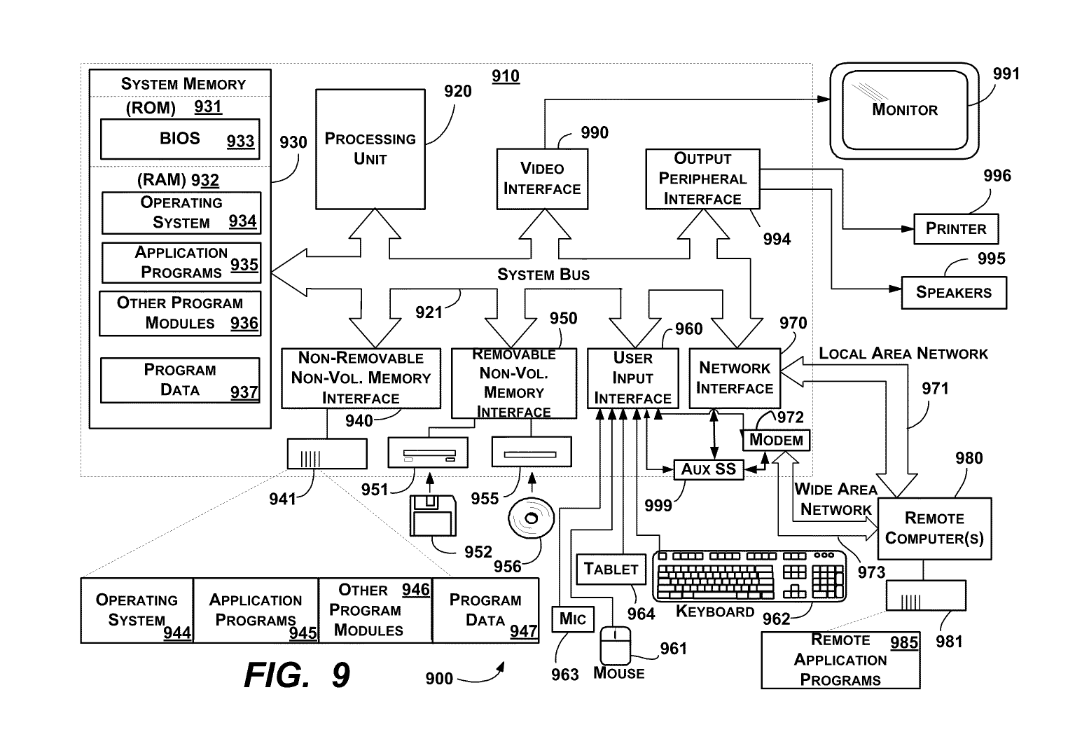

FIG. 9 illustrates an example of a suitable computing and networking environment 900 on which the examples of FIGS. 1-8 may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment 900.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 9, an exemplary system for implementing various aspects of the invention may include a general purpose computing device in the form of a computer 910. Components of the computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer-readable media. Computer-readable media can be any available media that can be accessed by the computer 910 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 910. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936 and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media, described above and illustrated in FIG. 9, provide storage of computer-readable instructions, data structures, program modules and other data for the computer 910. In FIG. 9, for example, hard disk drive 941 is illustrated as storing operating system 944, application programs 945, other program modules 946 and program data 947. Note that these components can either be the same as or different from operating system 934, application programs 935, other program modules 936, and program data 937. Operating system 944, application programs 945, other program modules 946, and program data 947 are given different numbers herein to illustrate that, at a minimum, they are different copies. A user may enter commands and information into the computer 910 through input devices such as a tablet, or electronic digitizer, 964, a microphone 963, a keyboard 962 and pointing device 961, commonly referred to as mouse, trackball or touch pad. Other input devices not shown in FIG. 9 may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. The monitor 991 may also be integrated with a touch-screen panel or the like. Note that the monitor and/or touch screen panel can be physically coupled to a housing in which the computing device 910 is incorporated, such as in a tablet-type personal computer. In addition, computers such as the computing device 910 may also include other peripheral output devices such as speakers 995 and printer 996, which may be connected through an output peripheral interface 994 or the like.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include one or more local area networks (LAN) 971 and one or more wide area networks (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960 or other appropriate mechanism. A wireless networking component such as comprising an interface and antenna may be coupled through a suitable device such as an access point or peer computer to a WAN or LAN. In a networked environment, program modules depicted relative to the computer 910, or portions thereof, may be stored in the remote memory storage device. By way of example, and not limitation, FIG. 9 illustrates remote application programs 985 as residing on memory device 981. It may be appreciated that the network connections shown are exemplary and other means of establishing a communications link between the computers may be used.

An auxiliary subsystem 999 (e.g., for auxiliary display of content) may be connected via the user interface 960 to allow data such as program content, system status and event notifications to be provided to the user, even if the main portions of the computer system are in a low power state. The auxiliary subsystem 999 may be connected to the modem 972 and/or network interface 970 to allow communication between these systems while the main processing unit 920 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising, a snapshot experimentation subsystem that runs experimental code related to web searches on offline data corresponding to a snapshot of actual web data, including an index building and serving component that uses the experimental code to build an experimental index based upon the offline data, and a mechanism for interacting with the experimentation subsystem to obtain search results.

2. The system of claim 1 further comprising an interface for uploading the experimental code to the snapshot experimentation subsystem.

3. The system of claim 1 further comprising a baseline index builder that builds a baseline index from other code that is not experimental, and a baseline retrieval engine that obtains search results based upon the baseline index for comparing against search results based upon the experimental index.

4. The system of claim 1 wherein the experimental index includes at least two index units that when combined provide indexing data.

5. The system of claim 1 further comprising a flexible search-related component, including means for ranking search results according to experimental ranking code, means for implementing an experimental search strategy, or means for generating experimental captions, or any combination of means for ranking search results according to experimental ranking code, means for implementing an experimental search strategy, or means for generating experimental captions.

6. The system of claim 1 further comprising a master component that schedules index building tasks of a plurality of users.

7. The system of claim 1 further comprising a front end component that allows user interaction with the snapshot experimentation subsystem.

8. The system of claim 1 further comprising an experimental repository that maintains page content and metadata for the snapshot experimentation subsystem.

9. The system of claim 8 further comprising a metadata extraction subsystem that processes documents and extracts features from the experimental repository for use by the snapshot experimentation subsystem.

10. The system of claim 1 wherein the snapshot comprises a full set of data obtained from the actual web data, or a partial subset of the full set of data based upon the actual web data.

11. In a computing environment, a system comprising, a snapshot experimentation subsystem that runs experimental code related to web searches on offline data corresponding to a snapshot of actual web data, including an experimental ranking component that uses the experimental code to rank search results based upon search results obtained from an index corresponding to the offline data, and a mechanism for interacting with the experimentation subsystem to obtain search results.

12. The system of claim 11 further comprising including an experimental index building and serving component that builds an experimental index from at least two index units, the experimental ranking component ranking search results based at least in part on data of the experimental index.

13. The system of claim 11 further comprising a master component that schedules ranking experiments for a plurality of users.

14. The system of claim 11 further comprising a front end component that allows user interaction with the snapshot experimentation subsystem.

15. The system of claim 11 further comprising an experimental repository that maintains page content and metadata for the snapshot experimentation subsystem.

16. The system of claim 15 further comprising a metadata extraction subsystem that processes documents and extracts features from the page content and metadata of the experimental repository for use by the snapshot experimentation subsystem.

17. The system of claim 11 wherein the snapshot comprises a full set of data obtained from the actual web data, or a partial subset of the full set of data based upon the actual web data.

18. The system of claim 11 further comprising means for implementing an experimental search strategy, or means for generating experimental captions, or both means for implementing an experimental search strategy and means for generating experimental captions.

19. In a computing environment, a system comprising:
an experimental repository that maintains page content and metadata synchronized from actual data used by a production search engine;
a metadata extraction subsystem that provides offline data by processing documents and extracting features based upon the page content and metadata of the experimental repository; and
a snapshot experimentation subsystem that runs experimental code related to web searches on the offline data, including:
a) to run experimental index building code to build an experimental index, or
b) to run experimental search-related code to rank search results according to experimental ranking code, to implement an experimental search strategy, or to generate experimental captions, or any combination of ranking search results, implementing an experimental search strategy, or to generating experimental captions, or
c) to both run experimental index building code and run experimental search-related code.

20. The system of claim 19 wherein the snapshot experimentation subsystem includes a master component that schedules experimental code running tasks for a plurality of users, and a front end component that allows user interaction with the snapshot experimentation subsystem.
